(19) United States
(12) Patent Application Publication
(10) Pub. No.: US 2019/0269570 A1
(43) Pub. Date: Sep. 5, 2019

(54) MASSAGE SYSTEM AND METHOD OF CONTROLLING AT LEAST ONE MASSAGE ACTUATOR

(71) Applicant: LOGICDATA Electronic & Software Entwicklungs GmbH, DEUTSCHLANDSBERG (AT)

(72) Inventors: Haymo NIEDERKOFLER, Graz (AT); Daniel KOLLREIDER, Graz (AT)

(73) Assignee: LOGICDATA Electronics & Software Entwicklungs GmbH, Deutschlandsberg (AT)

(21) Appl. No.: 16/308,426

(22) PCT Filed: Jun. 2, 2017
(86) PCT No.: PCT/EP2017/063532

§ 371 Date: Dec. 7, 2018

(30) Foreign Application Priority Data
Jun. 10, 2016 (DE) 10 2016 110 741.7

(51) Int. Cl. A61H 1/00; A61H 23/02; A61H 23/04

(52) U.S. Cl. CPC A61H 1/005; A61H 23/0263; A61H 23/04; A61H 2201/0146; A61H 2201/1223; A61H 2201/1238; A61H 2201/5005; A61H 2201/5061; A61H 2201/123

(57) ABSTRACT

A massage system for a bed having a mattress comprises a massage controller adapted to control at least one massage actuator acting on the mattress. The massage controller is adapted, in a calibration mode of operation, to drive the at least one massage actuator with a test signal for excitation of the mattress, to receive measured values which represent a response of the mattress to the excitation with the test signal, and to determine, on the basis of the measured values and the test signal, a response characteristic represented by an oscillation response of the massage actuator and the mattress. In addition, the massage controller is adapted to control, in a massage mode of operation, the at least one massage actuator based on an adjustable massage parameter and the oscillation response.

### BACKGROUND OF THE INVENTION

The present disclosure relates to a massage system, in particular for a bed with a mattress, and a method for controlling at least one massage actuator acting on a mattress.

In massage systems, different system sizes of bed, mattress etc. are typically unknown and variable during operation. Therefore, in the design and construction of such massage systems for the bed sector, conventional solutions usually do not take such system sizes into account. As a result, compromises are made in the design of massage systems with regard to the efficiency and effectiveness of the massage system. Accordingly, in many cases the massage effects that could theoretically be achieved cannot be achieved in practice.

### SUMMARY OF THE INVENTION

The present disclosure provides an improved control concept for massage systems, in particular in the bed sector, with which the effectiveness of the massage can be improved.

Massage systems in the bed sector typically have a mattress and at least one massage actuator acting on the mattress. The effect of the massage actuator through the mattress is transferred to a user of the massage system who, for example, lies on the mattress. How effective the massage is for the user depends, among other things, on the physical properties of the mattress, such as stiffness and damping characteristics. Quantitative information about these properties is usually not available. The improved control concept is based on the idea that a system identification related to one or more massage actuators and the associated mattress is carried out by appropriate feedback loops. For this purpose, for example, at least one massage actuator is driven with a test signal to excite the mattress. For system identification, measured values are then evaluated which represent a response of the mattress to the excitation with the test signal. The measured values can then be used to determine a response characteristic, for example represented by an oscillation response of the massage actuator and the mattress, in particular with knowledge of the test signal. After the system identification has been completed, this determined response characteristic or oscillation response can, for example in a regular operating mode, serve as the basis for controlling at least one massage actuator, for example taking into account an adjustable massage parameter. For example, the parameters of a massage can be adapted adaptively to a current overall system, which can consider in addition to mattress and massage actuator also a user of the massage system.

For example, according to the improved control concept, a massage system for a bed with a mattress comprises a massage controller which is arranged to control at least one massage actuator acting on the mattress. The massage controller is intended for operation in a calibration mode of operation and in a massage mode of operation. The massage controller is arranged in the calibration mode of operation to control the at least one massage actuator with the test signal for excitation of the mattress, to receive measured values which represent a response of the mattress to the excitation with the test signal, and to determine, on the basis of the measured values and the test signal, a response characteristic represented by an oscillation response of the massage actuator and the mattress. The massage controller is further arranged to control in the massage mode of operation the at least one massage actuator based on an adjustable massage parameter and the oscillation response.

For example, the response characteristic is determined by evaluating both the measured values and the underlying test signal. Preferably the user who wants to use the massage system in the massage mode is already on the mattress during the calibration mode. This allows a response characteristic represented by a oscillation response of the massage actuator and the mattress to be determined, which takes into account not only the properties of the mattress but also a load situation by the user, such as the weight of the user and/or a distribution of the load over the surface. Thus, the massage effect in the massage mode can also be optimally adapted to the user or the characteristics of the user.

In various implementations in accordance with the improved control concept, the massage controller is further arranged, in the massage mode, to drive the at least one massage actuator with a drive signal and to adapt a frequency and/or an amplitude of the drive signal based on the massage parameter and the oscillation response.

In different implementations according to the improved control concept, the massage controller is further arranged to determine or define different information for the massage mode from the measured values and/or the response characteristic. For example, an operating point for the massage actuator can be determined. Such an operating point is determined by a certain combination of parameters of the control signal, such as current, voltage, frequency, signal shape or the like. It is also possible to determine suitable operating parameters for controlling the massage actuator, which depend, for example, on the design or type of the massage actuator. In addition to current, voltage, frequency and signal form, such operating parameters can also be defined by the definition of a deflection or an applied force or comparable parameters.

A further information that can be determined from the measured values and/or the response characteristic for the massage mode is a system response of the massage actuator and the mattress, i.e. the knowledge of how the mattress reacts to a certain excitation by the massage actuator. Accordingly, a transfer characteristic between the massage actuator and the mattress can also be determined.

The massage actuators that can be used with the massage system can be designed in various ways. For example, a path-controlled and/or force-controlled actuator is used to generate the massage effect, which acts on the mattress and is arranged between the mattress and a fixed frame, for example. For example, special linear actuators can be used as massage actuators, which exert pressure on a certain part of the mattress by generating a linear movement. The massage effect can be achieved by corresponding linear movement during this application of pressure.

In another implementation of a massage actuator, for example, it is designed as a vibration motor and/or imbalance actuator. For example, an electric motor is equipped with an imbalance, for example in the form of an unevenly distributed mass, which leads to vibration when driven rotatably. The massage effect is generated by the vibration. The strength of the vibration depends, for example, on the speed of the imbalance actuator, wherein the effects of the mattress and/or the user also have an influence in the massage system.

The massage actuators controlled by the massage controller are not necessarily part of the massage system, but can also be part of the bed. For the determination of the response characteristic and the generation of the corresponding test signal, for example, it is sufficient if the kind or type of the massage actuator used is known in the massage controller. On the other hand, according to the improved control concept, it is not excluded that the massage system includes the massage actuator(s).

If more than one massage actuator is used, it is not excluded that the massage actuators have different specifications or are of different types.

In different implementations of the improved control concept, the test signal causes a variation of at least one of the following characteristics of the massage actuator to be controlled: a rotational speed, a frequency, an applied force, a deflection. With the different variation possibilities, a test signal can be used that controls the entire system consisting of massage actuator, mattress and, if applicable, user in adjustable bandwidth as representatively as possible in order to obtain sufficient information for the response characteristic in the desired area of application. The measured values can represent different reactions of the mattress to the excitation with the test signal, for example a force, a distance, a power, or a combination of the measurement variables mentioned.

To provide the measured values, the massage system can also include at least one sensor. Such a sensor is intended, for example, for measurement on or in at least one massage actuator. For example, measured values can be recorded in the massage actuator, such as a current in a motor of the actuator. Alternatively, such a sensor is only located in the vicinity of the massage actuator, e.g. on the mattress, in order to record corresponding measured values there.

Alternatively, measured values can also be received from corresponding, already existing sensors in or at the massage actuators. Therefore, the sensors are not necessarily part of the massage system.

Taking into account the various configurations described, the overall system consisting of mattress, massage actuator and, if necessary, user can also be regarded as an oscillation system. In the calibration mode, this oscillation system is excited by the test signal in order to determine the response characteristic from the received measured values, for example in the form of a system response. This can be used, for example, to determine parameters of a mathematical model for the overall system. Thus, the result of the calibration mode is a model with which the mode of excitation can be adapted to the prevailing load and mattress configuration.

For example, the massage controller is arranged to control at least one massage actuator in the massage mode based on the determined response characteristic and/or the massage parameter in such a way that a predetermined massage characteristic results. In addition, certain user settings can also be taken into account which predetermine the massage characteristic. In this case, the massage actuator is controlled in the massage mode based on the user settings. For example, the massage parameter can also be set by a user.

For example, the predetermined massage characteristic and/or the massage parameter is defined by at least one optimization criterion. For example, an optimization is performed with regard to a massage effect, a noise development, an energy requirement or a combination of the aforementioned. Further optimization criteria are not excluded.

In accordance with the improved control concept, a method is also proposed for controlling at least one massage actuator acting on a mattress with a calibration mode of operation and a massage mode of operation. In the calibration mode, at least one massage actuator is controlled with a test signal to excite the mattress. In the calibration mode, measured values are also received which represent a response of the mattress to the excitation with the test signal, and a response characteristic represented by an oscillation response of the massage actuator and mattress is determined from the measured values and the test signal. In the massage mode, at least one massage actuator is controlled based on an adjustable massage parameter and the oscillation response.

Various implementations of the method result directly from the previously described implementations of the massage system, in particular with regard to the realisation of a predetermined massage characteristic from the response characteristic.

### BRIEF DESCRIPTION OF THE DRAWINGS

The invention is explained in more detail below with reference to the drawings using examples. Here, similar elements or elements of the same function are designated with the same reference signs. Therefore, a repeated explanation of individual elements is omitted if necessary.

In the drawings:

FIG. 1 shows an example of a massage system with a bed,

FIG. 2 shows a schematic representation of another example of a massage system,

FIG. 3 shows an example of a massage actuator with a mattress,

FIG. 4 shows another example of a massage actuator, and

FIG. 5 shows an exemplary signal diagram of a massage actuator.

### DETAILED DESCRIPTION

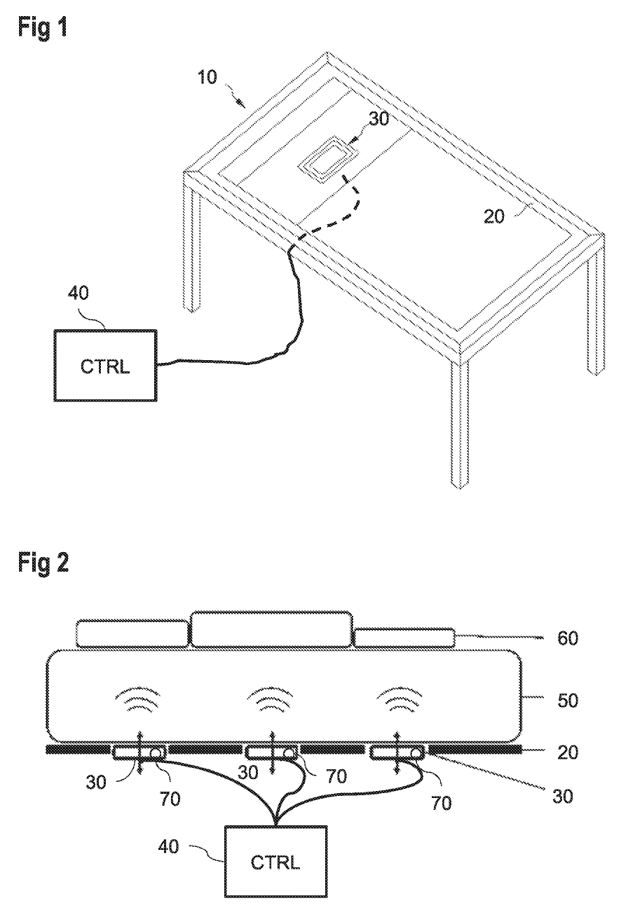

FIG. 1 shows an example of a massage system according to the improved control concept in combination with a bed 10. The bed 10 shows an exemplary support 20 for a mattress not shown. In addition, a support for a massage actuator 30 is provided on the support 20, which is connected to a massage controller 40. If, according to an intended application, a mattress is placed on the support 20 or the massage actuator 30, a massage effect through the mattress can be achieved by corresponding control of the massage actuator 30 through the massage controller 40. The massage actuator 30 is exemplarily indicated as a vibration motor, but can also be replaced in alternative implementations with other types of massage actuators, which will be explained in more detail later.

In contrast to conventional massage systems in the bed sector, this massage system with massage controller 40 is not only designed for simple control of the massage actuator 30. In fact, according to the improved control concept, the massage controller 40 is intended for operation in a calibration mode of operation and in a massage mode of operation. In the calibration mode, the massage controller 40 controls the massage actuator 30 with a test signal to excite the mattress. In addition, the massage controller 40 receives measured values, which represent a response of the mattress to the excitation with the test signal. Finally, the massage controller 40 determines a response characteristic from the measured values represented by a oscillation response of the massage actuator 30 and the mattress.

In the massage mode, the massage controller 40 is arranged to control the massage actuator 30 based on an adjustable massage parameter and the oscillation response. Although only one massage actuator 30 is shown in FIG. 1, it is also possible to provide a larger number of massage actuators that interact with the shown massage actuator. The control of several massage actuators is also carried out via the common massage controller 40, which can also receive a larger number of measured values if applicable.

The massage actuator(s), the mattress and, if applicable, a user of the massage system form an overall system whose physical properties are initially unknown. The overall system can also be considered as an oscillation system. In accordance with the improved control concept, in the calibration mode a defined excitation of the system is stimulated on the basis of the test signal, whereby the output quantities of the oscillation system are evaluated. For this purpose, appropriate sensors are provided, for example.

With reference to FIG. 2, a schematic representation of such an overall system is shown, in which a mattress 50 is arranged on the support 20. The mattress 50 schematically shows a user 60 sketched by his weight distribution. In support 20, for example, three massage actuators 30 are arranged, which can introduce force or vibrations into the mattress 50, which is symbolically shown. In the massage actuators 30, for example, the respective sensors 70 are provided, which transmit the corresponding measured values to the massage controller 40.

As explained above, the entire oscillation system is excited by the massage actuators 30 with a previously defined test signal. The measured values measured by the sensors 70 represent, for example, a system response which can be used to determine the response characteristic, especially of the overall system. For example, the response characteristic can be defined by parameters of a mathematical model that can be determined from the measured values, especially taking into account the test signal. As a result of the calibration mode, for example, a model is available with which the way of excitation can be adapted to the configuration of load and mattress. This model can be used in massage mode, for example to achieve a predetermined massage characteristic. For example, the model represents a oscillation response of massage actuator 30 and mattress 50.

For example, the measured values and/or the response characteristic can be used to determine an operating point for the massage actuator(s) in the massage mode. Alternatively or additionally, the measured values and/or the response characteristic also serve to determine operating parameters in massage mode for controlling the massage actuator(s) 30. Further possibilities are the determination of a system response of massage actuator 30 and mattress 50 and/or a transfer characteristic between massage actuator 30 and mattress 50. The determination of the above results is not mutually exclusive.

On the basis of the results from the calibration mode, the operation of the massage system in the massage mode can be optimized with regard to one or more criteria. For example, an optimization of the massage effect, a noise development, an energy demand or similar criteria as well as a combination of the mentioned criteria can be considered.

The setting for the massage mode is not only based on the results of the calibration mode, but also on user settings, e.g. in the form of an adjustable massage parameter. For example, the user can set a desired massage intensity, but this can only be achieved if the system properties are known. Accordingly, operation in massage mode is based on the determined response characteristic and the desired massage characteristic of the user. Of course, the user can also influence other criteria, in particular the optimization criteria, if this is supported by the massage system or the massage control. For this purpose, appropriate input means are to be provided which are not shown here for reasons of simplicity.

The design of the test signal also depends, among other things, on the design of the massage actuator used. The test signal can also include the control of several different massage actuators.

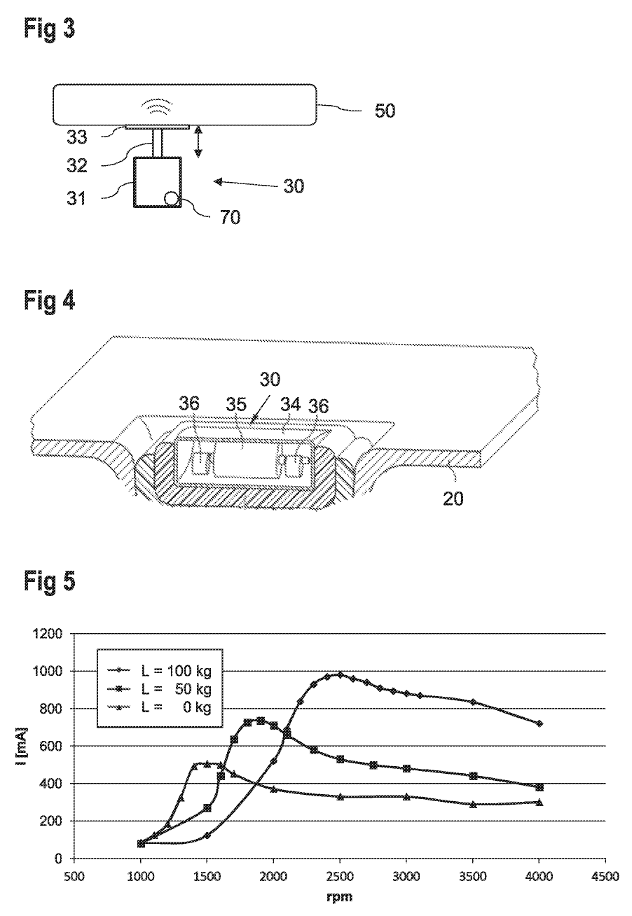

For example, FIG. 3 shows a detail of a massage system with a mattress 50, which is excited by a massage actuator 30 designed as a linear actuator. The massage actuator 30 has a linear motor 31, a lifting rod 32 and a plunger or support 33, with which pressure is finally exerted on the mattress 50. A sensor 70 is provided in the motor 31. Instead of the linear motor 31, other types of linear actuators can also be used, such as pneumatic, hydraulic, swashplate or similar actuators.

In order to be able to determine the response characteristic or the oscillation response of the system as comprehensively as possible, the test signal for controlling the massage actuator 30 is varied, for example, with regard to the vertical deflection of the lifting rod 32 or the support 33 and the frequency with which the vertical movement takes place. Alternatively or additionally, the force applied for the vertical movement can also be determined or varied in the test signal. For example, measurement parameters can be the current applied to the movement or the power applied, the deflection achieved, or a force applied. From the results, the optimal parameters for the massage mode, defined by various optimization criteria, can be determined, for example.

FIG. 4 shows a further implementation of a massage actuator 30 in a massage system according to the improved control concept. The massage actuator 30 is attached to the support 20 as a vibration motor or imbalance actuator. For reasons of simplicity, the mattress 50 to be applied to the support 20 during operation is not shown. The massage actuator 30 comprises a housing 34 in which a rotating motor 35 is provided. The laterally mounted axial drive axles are provided with unbalanced weights 36 with eccentric bearings. When the motor 35 is rotated, these unbalanced weights 36 lead to an unbalance, which is transmitted as vibration to the housing 34 and a mattress mounted on it.

In calibration mode, for example, a motor 35 speed is varied by the test signal. For example, the current consumption of the motor is measured as a function of the speed.

FIG. 5 shows an exemplary signal diagram of measurement series of the motor current as a function of the pre-set speed for a massage actuator designed as an imbalance actuator. The three measurement curves shown are for different loads on the overall system. For example, the curve marked with triangles represents a load L of 0 kg, the curve marked with squares represents a load L of 50 kg and the curve marked with diamonds represents a load L of 100 kg.

It can be seen that a current maximum of the respective curves results for different speeds. In particular, it can be seen that the current consumption of the motor shifts towards higher speeds as the load increases. For example, subjective assessments showed that the best massage effects could be achieved in the maxima of the respective current speed curves. According to the improved control concept, this information can be used, for example, to shift the operating point in the form of the motor speed to the appropriate range depending on the respective user and/or selected massage program.

While the example in FIG. 5 shows an optimization for the massage mode based on a speed with the maximum current, suitable optimization criteria can be defined for other types of massage actuators, for example. For example, a current-dependent minimum noise optimization for a particular type of massage actuator can also be found in advance, which is then applied based on the measurements in calibration mode. Alternatively, other measurement parameters can be recorded, such as a volume level via a microphone mounted in the mattress or on the massage actuator.

1. A massage system for a bed having a mattress, the massage system comprising a massage controller arranged to control at least one massage actuator acting on the mattress,
wherein the massage controller is further arranged, in a calibration mode of operation,
to drive said at least one massage actuator with a test signal for excitation of the mattress;
to receive measured values representing a response of the mattress to the excitation with the test signal; and
to determine, on the basis of the measured values and the test signal, a response characteristic represented by an oscillation response of the massage actuator and the mattress;
and
wherein the massage controller is further adapted to control, in a massage mode of operation, the at least one massage actuator based on an adjustable massage parameter and the oscillation response.

2. The massage system according to claim 1,
wherein the massage controller is further arranged, in the massage mode of operation, to drive the at least one massage actuator with a drive signal, and to set a frequency and/or an amplitude of the drive signal based on the massage parameter and the oscillation response.

3. The massage system according to claim 1,
wherein the massage controller is further arranged to determine from the measured values and/or the response characteristic for the massage mode of operation at least one of the following:
an operating point for the massage actuator;
operating parameters for controlling the massage actuator;
a system response of the massage actuator and the mattress;
a transfer characteristic between the massage actuator and the mattress.

4. The massage system according to claim 1,
wherein the test signal causes a variation of at least one of the following characteristics of the massage actuator:
a rotational speed;
a frequency;
an applied force;
a deflection.

5. The massage system according to claim 1,
wherein the measured values represent at least one of the following quantities:
a force;
a distance;
a power.

6. The massage system according to claim 1,
further comprising at least one sensor which is provided for measurement at or in the massage actuator for providing the measured values.

7. The massage system according to claim 1,
wherein the massage controller is arranged, in the massage mode of operation, to control the at least one massage actuator based on the determined response characteristic and/or the massage parameter such that a predetermined massage characteristic results.

8. The massage system according to claim 1,
wherein the massage controller is arranged, in the massage mode of operation, to control the at least one massage actuator based on the determined response characteristic and on user settings such that a predetermined massage characteristic results, which is predetermined by the user settings.

9. The massage system according to claim 7,
wherein the predetermined massage characteristic and/or the massage parameter is defined by at least one optimization criterion aimed at at least one of the following:
a massage effect;
a noise development;
an energy requirement.

10. The massage system according to claim 1,
wherein the massage parameter is adjustable by a user.

11. A method of controlling at least one massage actuator acting on a mattress having a calibration mode of operation and a massage mode of operation, the method comprising:
in the calibration mode of operation, driving the at least one massage actuator with a test signal for excitation of the mattress;
in the calibration mode of operation, receiving measured values representing a response of the mattress to the excitation with the test signal and determining from the measured values and the test signal a response characteristic represented by an oscillation response of the massage actuator and the mattress; and
in the massage mode of operation, controlling the at least one massage actuator based on an adjustable massage parameter and the determined oscillation response.

12. The method according to claim 11,
wherein, in the massage mode of operation, the at least one massage actuator is driven with a drive signal, and wherein a frequency and/or an amplitude of the drive signal are adjusted based on the massage parameter and the oscillation response.

13. The method according to claim 11,
wherein, in the massage mode of operation, the at least one massage actuator is actuated based on the determined response characteristic and/or the massage parameter such that a predetermined massage characteristic results.

14. The method according to claim 11,
wherein, in the massage mode of operation, the at least one massage actuator is actuated on the basis of the determined response characteristic and of user settings such that a predetermined massage characteristic results which is determined by the user settings.

15. The method according to claim 11,
in which the massage parameter is adjustable by a user.

16. The massage system according to claim 1,
wherein the massage controller is further arranged to receive the measured values from at least one sensor.

17. The massage system according to claim 1, wherein
the mattress and the at least one massage actuator form an oscillation system;
the test signal serves to excite the oscillation system; and
the measured values represent a response of the oscillation system to the excitation with the test signal.
